(19) United States
(12) Patent Application Publication
(10) Pub. No.: US 2023/0100845 A1
(43) Pub. Date: Mar. 30, 2023

(54) ELECTRODE INCLUDING CELLULOSE DERIVATIVE COMPOSITION FOR ALL-SOLID-STATE SECONDARY BATTERY BINDER

(71) Applicant: ELECTRONICS AND TELECOMMUNICATIONS RESEARCH INSTITUTE, Daejeon (KR)

(72) Inventors: Dong Ok SHIN, Daejeon (KR); Young-Gi Lee, Daejeon (KR); Jaecheol Choi, Daejeon (KR); Seok Hun Kang, Daejeon (KR); Ju Young Kim, Daejeon (KR); Young Sam Park, Daejeon (KR)

(21) Appl. No.: 17/945,794

(22) Filed: Sep. 15, 2022

(30) Foreign Application Priority Data
Sep. 17, 2021 (KR) 10-2021-0124485
Feb. 9, 2022 (KR) 10-2022-0017200

(51) Int. Cl. H01M 4/62; H01M 4/583; H01M 10/0525

(52) U.S. Cl. CPC H01M 4/622; H01M 4/583; H01M 10/0525; H01M 2004/021

(57) ABSTRACT

Provided is a cellulose derivative composition for an all-solid-state secondary battery binder including a compound represented by Formula 1 below according to the inventive concept.

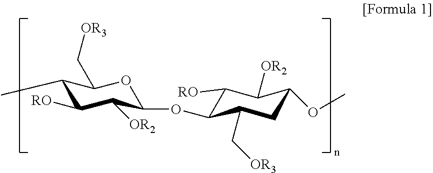

In Formula 1, R₁, R₁′, R₂, R₂′, R₃, and R₃′ are each independently any one among a carboxymethyl group, a sulfur substituent, or a phosphorus substituent, in which a monovalent metal is substituted or hydrogen, wherein R₁, R₂, and R₃ is —CH₂COOX, , SO₃X, —PO₃X or —PO₃X₂ where X may be any one among sodium (Na), potassium (K), rubidium (Rb), or cesium (Cs). R₁′, R₂′, and R₃′ is —CH₂COOY, —SO₃Y, —PO₃Y or —PO₃Y₂ where Y may be lithium (Li).

### CROSS-REFERENCE TO RELATED APPLICATIONS

This U.S. non-provisional patent application claims priority under 35 U.S.C. § 119 of Korean Patent Application Nos. 10-2021-0124485, filed on Sep. 17, 2021, and 10-2022-0017200, filed on Feb. 9, 2022, the entire contents of which are hereby incorporated by reference.

### BACKGROUND

The present disclosure herein relates to an electrode including a cellulose derivative composition for an all-solid-state secondary battery binder, and more particularly, to an electrode including a cellulose derivative composition for an all-solid-state secondary battery binder in which metal ions are multi-substituted.

Lithium secondary batteries have a higher energy density than other batteries and can be made small and light, and thus, are highly likely to be used as a power source for mobile electronic devices and the like. The lithium ion batteries show higher storage capacity, better charging/discharging characteristics, and higher processabilities than other energy storages such as capacitors and fuel cells, and thus are greatly highlighted as next-generation energy storage devices of wearable devices, electric vehicles, and energy storage systems (ESS).

The lithium secondary batteries may include a positive electrode, a negative electrode, and an electrolyte. Typically, as a liquid electrolyte, a carbonate-based solvent in which lithium salt (LiPF₆) is dissolved is widely used. The liquid electrolyte has a high mobility of lithium ions, and thus, exhibits excellent electrochemical properties. However, there is a concern about safety due to an explosion caused by high flammability, volatility, and leakage of the liquid electrolyte.

Against this backdrop, research into an all-solid-state secondary battery using a solid electrolyte instead of a liquid electrolyte has been underway. As the all-solid-state secondary battery is capable of ensuring stability and mechanical strength to prevent fire, explosion, and leakage at source, and thus, is attracting attention in various application systems that require high stability, such as electric vehicles, energy storage systems, wearable devices, and the like.

### SUMMARY

An embodiment of the inventive concept provides a cellulose derivative composition for an all-solid-state secondary battery binder including a compound represented by Formula 1 below according to the inventive concept.

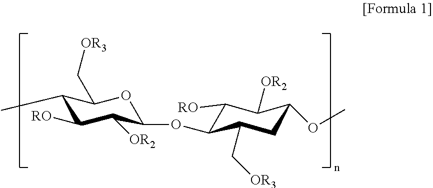

In Formula 1, R₁, R₁′, R₂, R₂′, R₃, and R₃′ are each independently any one among a carboxymethyl group, a sulfur substituent, or a phosphorus substituent, in which a monovalent metal is substituted, or hydrogen.

R₁, R₂, and R₃ is —CH₂COOX, SO₃X, —PO₃X or —PO₃X₂ where X may be any one among sodium (Na), potassium (K), rubidium (Rb), or cesium (Cs). R₁′, R₂′, and R₃′ is —CH₂COOY, —SO₃Y, —PO₃Y or —PO₃Y₂ where Y may be lithium (Li).

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a cross-sectional view showing an all-solid-state secondary battery including a cellulose derivative composition for an all-solid-state secondary battery binder according to an embodiment of the inventive concept;

FIG. 2 is a flowchart showing a method of manufacturing a negative electrode of an all-solid-state secondary battery according to an embodiment of the inventive concept;

FIG. 3 is a graph showing the number of microgels in a binder solution in Examples 1 to 3 and Comparative Example 1;

FIG. 4 is a chart showing lithium substitution rates in cellulose derivative binders in Examples 4 to 5 and Comparative Example 2;

FIG. 5 is a microscope image of cellulose derivatives in Examples 6 and 7 and Comparative Example 3;

FIG. 6 is a graph of chemical composition analysis in Examples 8 and 9 and Comparative Example 4;

FIG. 7 is a graph showing charge/discharge capacity of negative electrodes in Examples 10 and 11 and Comparative Example 5; and

FIG. 8 is a graph showing internal resistance of negative electrodes in Examples 12 and 13 and Comparative Example 6.

### DETAILED DESCRIPTION

Advantages and features of the present disclosure and methods of accomplishing the same may be understood more readily by reference to the following detailed description of embodiments and the accompanying drawings. However, the present disclosure may be embodied in different forms, and these embodiments are provided only to make this disclosure thorough and complete and to fully convey the scope of the present disclosure to those skilled in the art, and thus the present disclosure is defined only by the scope of the appended claims. Like reference numerals denote like elements throughout specification.

Terms used herein are not for limiting the present disclosure but for describing the embodiments. In this specification, the singular forms include the plural forms as well, unless the context clearly indicates otherwise. It will be further understood that the terms “comprises” and/or “comprising”, when used ‘in this description, specify the presence of stated elements, steps, operations, and/or components, but do not preclude the presence or addition of one or more other elements, steps, operations, and/or components.

Additionally, the embodiments described in this description will be explained with reference to the cross-sectional views and/or plan views as ideal example views of the present disclosure. In the drawing, the thicknesses of films and regions are exaggerated for effective description of the technical contents. Therefore, a form of an example view may be modified by a manufacturing method and/or tolerance. Accordingly, the embodiments of the present disclosure are not limited to the specific shape illustrated in the example views, but may include other shapes that are created according to manufacturing processes. Thus, areas exemplified in the drawings have general properties, and shapes of the exemplified areas are used to illustrate a specific shape of a device region. Therefore, this should not be construed as limited to the scope of the present disclosure.

Unless otherwise defined, the terms used in embodiments of the inventive concept may be interpreted as meaning commonly known to those skilled in the art.

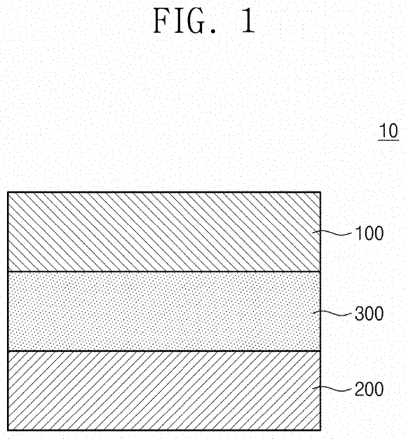

FIG. 1 is a cross-sectional view showing an all-solid-state secondary battery including a cellulose derivative composition for an all-solid-state secondary battery binder according to an embodiment of the inventive concept.

Referring to FIG. 1, an all-solid-state secondary battery 10 according to an embodiment of the inventive concept may include a positive electrode 100, a negative electrode 200, and a solid electrolyte layer 300. The positive electrode 100 and the negative electrode 200 may be disposed to face each other with the solid electrolyte layer 300 therebetween.

The all-solid-state secondary battery 10 may be, for example, a lithium secondary battery. The positive electrode 100 may include a positive electrode active material. The positive electrode active material may include at least one of sulfur, lithium sulfur, LiCoO₂, LiNiO₂, LiNiₓCo_{y}Mn_{z}O₂ (x+y+z=1), LiMn₂O₄, or LiFePO₄.

The positive electrode 100 may further include a conductive material. The conductive material may improve electrical conductivity of the positive electrode 100. For example, the conductive material may include at least any one of conductive amorphous carbon, carbon nanotubes, or graphene.

The negative electrode 200 may include a negative electrode active material. The negative electrode active material may include at least any one of a high-capacity negative electrode material coated with an electronic conductive layer such as graphite, hard carbon, soft carbon, carbon nanotubes, graphene, redox graphene, carbon fiber, amorphous carbon, and silicon-carbon composite (SiC) (silicon or silicon oxide (SiOx), tin (Si), cobalt oxide (CoOx), and iron oxide (FeOx)).

The positive electrode 100 and the negative electrode 200 may not include an electrolyte. In general, an electrolyte may be added to the positive electrode 100 and the negative electrode 200 of the all-solid-state secondary battery 10. As a cellulose derivative composition according to an embodiment of the inventive concept, which will be described later, is included in a mixed binder composition, an electrolyte is not added to the positive electrode 100 and the negative electrode 200, and accordingly, even when an ion transport path in the electrode is not secured, an additional lithium ion transfer path may be provided through a binder, thereby lowering interfacial resistance inside a secondary battery and enabling fast transfer of lithium ions.

The negative electrode 200 may further include a mixed binder composition. The mixed binder composition may include a cellulose derivative composition and styrene-butadiene rubber (SBR) emulsion. Accordingly, the mixed binder composition may be a mixed aqueous binder.

The cellulose derivative composition may include a compound represented by Formula 1 below.

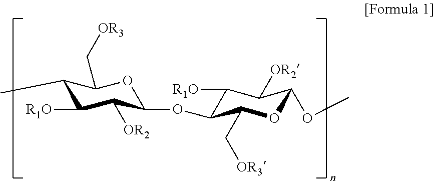

In the compound, R₁, R₁′, R₂, R₂′, R₃, and R₃′ present in a polymer structure are functional groups of a repeating unit, and may each independently have a structure of any one among a carboxymethyl group, a sulfur substituent, a phosphorus substituent, in which a first monovalent metal (X) or a second monovalent metal (Y) is substituted, or hydrogen.

The carboxymethyl group corresponding to R₁, R₂, or R₃ is —CH₂COOX where X may be any one among sodium (Na), potassium (K), rubidium (Rb), or cesium (Cs). The carboxymethyl group corresponding to R₁′, R₂′, or R₃′ is —CH₂COOY where Y may be lithium (Li).

The sulfur substituent corresponding to R₁, R₂, or R₃ is —SO₃X where X may be any one among sodium (Na), potassium (K), rubidium (Rb), or cesium (Cs). The sulfur substituent corresponding to R₁′, R₂′, or R₃′ is —SO₃Y where Y may be lithium (Li).

The phosphorus substituent corresponding to R₁, R₂, or R₃ is —PO₃X or —PO₃X₂ where X may be any one among sodium (Na), potassium (K), rubidium (Rb), or cesium (Cs). The phosphorus substituent corresponding to R₁′, R₂′, or R₃′ are —PO₃Y or —PO₃Y₂ where Y may be lithium (Li).

The functional group corresponding to R₁, R₂, or R₃ may include a first monovalent metal, and the functional group corresponding to R₁′, R₂′, or R₃′ may include a second monovalent metal. In this case, the first monovalent metal may be any one among sodium (Na), potassium (K), rubidium (Rb), or cesium (Cs), and the second monovalent metal may be lithium (Li). Each of the first monovalent metal and the second monovalent metal may be an alkali metal. That is, the cellulose derivative composition may be a composition in which alkali metal ions are multi-substituted. R₁, R₂, R₃, R₁′, R₂′, or R₃′ which is not formed of a functional group in which metal ions are substituted may be hydrogen.

In typical binder compositions, due to strong hydrophobic properties of a cellulose polymer, a large number of microgels that are not sufficiently dissolved in aqueous solution and aggregated (a case in which polymer chains are not completely dissolved and swollen by a solvent) may be formed. When these microgels are still left when an electrode slurry is prepared, scratches are formed on an electrode plate upon coating, or a thickness of an electrode is partially greater in the portion where microgels are aggregated, thereby increasing the chances of short circuit or leakage current. That is, electrical properties of an all-solid-state secondary battery may be deteriorated.

According to embodiments of the inventive concept, the monovalent metal ions are substituted in the cellulose derivative composition to suppress strong hydrophobicity between cellulose polymers, thereby maintaining high solubility in aqueous solution. Accordingly, the formation of microgels may be reduced to solve the above-described issues.

In addition, the cellulose derivative composition according to embodiments of the inventive concept may include a substituent in which lithium ions are substituted. Accordingly, conductive properties of lithium ions are improved, and thus, even when an electrolyte component is excluded from an electrode, a lithium ion transfer path is provided through a binder, thereby lowering interfacial resistance inside a secondary battery and enabling fast transfer of lithium ions. As a result, electrochemical performance of an all-solid-state secondary battery electrode may be improved.

The cellulose derivative composition may include cellulose, methyl cellulose, ethyl cellulose, butyl cellulose, hydroxypropyl cellulose, cellulose nitrate, cellulose acetate, cellulose acetate propionate, cellulose acetate butyrate, or carboxymethyl cellulose, or at least any one derivative of xanthan gum, pectin, guar gum, or dextran. The cellulose derivative composition may include a structure in which carboxylic acid, sulfonic acid, phosphoric acid, and the like are substituted in the structure of cellulose derivatives.

A weight ratio of active material particles in the negative electrode 200 may be about 80 wt % to about 99 wt %, preferably about 90 wt % to about 99 wt %. In the mixed binder composition, a weight ratio between a cellulose derivative and SBR emulsion may be about 99:1 to about 1:99, preferably about 90:10 to about 60:40. The cellulose derivative composition may also be applied to the positive electrode 100.

The solid electrolyte layer 300 may be disposed between the positive electrode 100 and the negative electrode 200. The solid electrolyte layer 300 may serve to transfer ions to the positive electrode 100 and the negative electrode 200.

The solid electrolyte layer 300 may include at least any one of an oxide-based material, a phosphate-based material, a sulfide-based material, or a polymer-based material. An inorganic solid electrolyte layer 300 may be formed in the form of a film having a predetermined thickness of about 30 to about 2000 m through a cold or high temperature sintering process. The solid electrolyte layer 300 formed of a polymer-based material or a composite electrolyte mixed with an inorganic solid electrolyte may be formed in the form of a film having a predetermined thickness of about 30 to about 1000 m through an application method. For example, the solid electrolyte layer 300 may further include at least any one of a polymer binder, an organic scaffold, or an inorganic scaffold. The polymer binder, the organic scaffold, or the inorganic scaffold may increase mechanical strength of the solid electrolyte layer 300. The polymer binder may include, for example, at least one of polytetrafluoroethylene, polyvinylidene fluoride, poly(ethylene oxide), polyacrylonitrile, hydroxypropyl cellulose, carboxymethyl cellulose, styrene-butadiene, or nitrile-butadiene rubber. For another example, the solid electrolyte layer 300 may not include a polymer binder, an organic scaffold, or an inorganic scaffold.

For example, an oxide-based material of the solid electrolyte layer 300 may include a garnet-type material having a composition of Li_{7-3x+y-z}AₓLa_{3-y}B_{y}Zr_{2-z}C_{z}O₁₂. In this case, A may be any one of aluminum (Al) and gallium (Ga), B may be any one among calcium (Ca), strontium (Sr), and barium (Ba), and C may be any one among tantalum (Ta), niobium (Nb), antimony (Sb), and bismuth (Bi). In particular, in the case of an oxide-based material having a structure of Li₇₋ₓAₓLa₃Zr₂O₁₂, materials in which Li site is doped with elements such as aluminum and gallium as doping elements (0˜0.3 mol ratio) and Zr site is doped with elements such as niobium and tantalum as doping elements (0˜0.3 mol ratio) may be used. For another example, the oxide-based material may include Li₃ₓLa_{(2/3)-x□(1/3)-2x}TiO₃ (LLTO, 0<x<0.16, □: vacancy) as a material having a perovskite structure.

The phosphate-based material of the solid electrolyte layer 300 may include, for example, a material having a NAISICON structure such as Li₁₊ₓAlₓTi₂₋ₓ(PO₄)₃ (x=0˜0.4).

The sulfide-based material of the solid electrolyte layer 300 may include, for example, a material having a composition of Li_{10±1}MP₂X₁ (where M may be any one among germanium (Ge), silicon (Si), tin (Sn), aluminum (Al), or phosphorus (P) where X may be any one of sulfur (S) and selenium (Se)). For example, any one material selected from the group of compounds that basically contain a chalcogenide element and lithium, such as materials such as Li₁₀SnP₂S₁₂ and Li_{4-X}Sn_{1-X}AsₓS₄ (x=0˜100), materials such as Li_{3.25}Ge_{0.25}P_{0.75}S₄ and Li₁₀GeP₂S₁₂, which are thio-lithium superionic conductor (thio-LISICON) groups, materials such as Li₆PS₅Cl which is a Li-argyrodite Li₆PS₅X group (where X is any one among chlorine (Cl), bromine (Br) or iodine (I)), materials selected from the group of Li₂S.P₂S₅ (xLi₂S (100˜x)P₂S₅, x=0˜100) having a glass-ceramic structure, and materials such as Li₂.P₂S₅, Li₂S.SiS₂.Li₃N, Li₂S.P₂S₅.LiI, Li₂S.SiS₂.LiₓMO_{y}, Li₂S.GeS₂, and Li₂S.B₂S₃.LiI, which are groups having a glass structure may be included.

The polymer-based material of the solid electrolyte layer 300 may include, for example, at least any one of polyethylene oxide (PEO), polyvinyl chloride (PVC), polyacrylonitrile (PAN), poly(methyl methacrylate) (PMMA), polyvinylidene fluoride (PVDF), or polyvinylidene fluoride-hexafluoropropylene P(VDF-HFP)) copolymer. In this case, lithium salt contained in the polymer-based material may include at least any one of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, (CF₃SO₂)₂NLi, LiFSI, LiTFSI, LiBETI, LiBPB, LiCTFSI, LiTDI, or LiPDI.

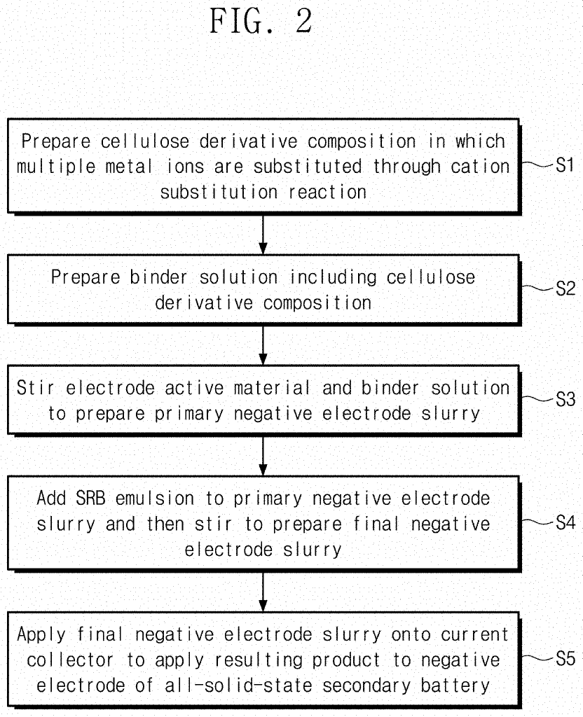

FIG. 2 is a flowchart showing a method of manufacturing a negative electrode of an all-solid-state secondary battery according to an embodiment of the inventive concept.

A method of manufacturing the negative electrode 200 of the all-solid-state secondary battery 10 according to an embodiment of the inventive concept will be described with reference to FIG. 2. In the present embodiment, the method of manufacturing the negative electrode 200 will be described, but processes which will be described later may be applied to the positive electrode 100 as well as the negative electrode 200.

The method of manufacturing the negative electrode 200 of the all-solid-state secondary battery 10 according to an embodiment of the inventive concept may include preparing a cellulose derivative composition in which multiple metal ions are substituted through a cation substitution reaction (S1), preparing a binder solution including the cellulose derivative composition in which multiple metal ions are substituted (S2), stirring an electrode active material and the binder solution to prepare a primary negative electrode slurry (S3), adding SBR emulsion to the primary negative electrode slurry and then stirring to prepare a final negative electrode slurry (S4), and applying the final negative electrode slurry onto a current collector to apply the resulting product to a negative electrode of an all-solid-state secondary battery (S5).

A cellulose derivative composition in which multiple metal ions are substituted may be prepared through a cation substitution reaction (S1). For example, a Na-CMC (carboxymethyl cellulose) binder is added in 150 ml of ethanol/water (de-ionized water) solution containing lithium hydroxide monohydrate (LiOH.H₂O) and making the mixture react for 1 hour to induce a sodium/lithium cation (Na+/Li+) substitution reaction, thereby preparing a cellulose derivative composition in which metal ions are substituted.

A binder solution including the cellulose derivative composition in which multiple metal ions are substituted may be prepared (S2). As an example, a sodium/lithium cation (Na+/Li+) substitution reaction may be induced to synthesize a (Na+Li)-CMC binder, using vacuum filtering and vacuum drying processes for the cellulose derivative composition in which metal ions are substituted. The (Na+Li)-CMC binder may be dissolved in a solvent (e.g., water) to prepare a binder solution.

An electrode active material and the binder solution may be stirred to prepare a primary negative electrode slurry (S3). The electrode active material applied to a negative electrode is good for mechanical deformation and has high electronic conductivity (2 S/cm or greater), and may include at least any one of a high-capacity negative electrode material coated with an electronic conductive layer such as graphite, hard carbon, soft carbon, carbon nanotubes, graphene, redox graphene, carbon fiber, amorphous carbon, and silicon-carbon composite (SiC) (silicon or silicon oxide (SiOx), tin (Si), cobalt oxide (CoOx), and iron oxide (FeOx)).

To be specific, the binder solution may be uniformly mixed with the electrode active material to form a primary negative electrode slurry. In this case, a weight ratio of the electrode active material and the binder solution may be between about 80:20 and about 99:1, preferably between about 90:10 and about 99:1.

After adding the SBR emulsion to the primary negative electrode slurry and stirring, a final negative electrode slurry may be prepared (S4). To be specific, a weight ratio between the cellulose derivative composition of the primary negative electrode slurry and the SBR emulsion may be about 99:1 to about 1:99, preferably about 90:10 to about 60:40.

The final negative electrode slurry is applied onto a current collector to apply the resulting product to the negative electrode of an all-solid-state secondary battery (S5). To be specific, the final negative electrode slurry as a thick film is applied onto the current collector. The applying of the slurry may be performed through thickening processes such as a gravure coater method, a small diameter gravure coater method, a reverse roll coater method, a transfer roll coater method, a kiss coater method, a dip coater method, a knife coater method, an air doctor blade coater method, a blade coater method, a bar coater method, a die coater method, a screen printing method, and a spray application method. After the applying, a solvent component of the final negative electrode slurry is removed through high temperature drying and vacuum drying processes. In the process of applying a slurry, a thickness of the negative electrode 200 may be adjusted between several micrometers and several hundreds of micrometers. Upon drying, the temperature is applied between 80 to 120° C., and drying is performed in a vacuum for about 10 to 20 hours to satisfy the residual solvent content of several ppm or less. Thereafter, the contact between the coated electrode active material particles is improved through a compression process at a pressure of 100 to 350 MPa. For example, a hot-press process may be performed at a temperature between 100 and 300° C. to reduce porosity. A pore density of the electrode after pressing is about 10 to 20%, preferably 5% or less.

The solid electrolyte layer 300 and a counter electrode may be formed on the electrode. For example, the electrode may be the negative electrode 200, and the counter electrode may be the positive electrode 100. The current collector may be formed of a material such as lithium, sodium, magnesium, or potassium in the form of foil or powder. The positive electrode 100 and the negative electrode 200 may include the current collector. The electrode and the counter electrode may be electrodes prepared through the above-described processes S1 to S5.

Lastly, an all-solid-state secondary battery formed of an electrode/solid electrolyte layer/counter electrode is compressed at a pressure of 50 to 100 MPa to form a fully bonded electrode/electrolyte interface. A hot-press process may be performed to form a fully bonded interface. When the final pressure process is not applied, high interfacial resistance may be caused due to unstable contact between an electrode and an electrolyte, which may deteriorate properties of a battery.

To evaluate solubility of the cellulose derivative composition in aqueous solution, a binder solution (1 to 2 wt % de-ionized water) was prepared and applied to a transparent sheet through a doctor blade method to analyze the number of microgels (Examples 1 to 3 and Comparative Example 1 below). When preparing the binder solution, a mixing process was applied at 1500 to 2000 rpm using a mixer, and the time for the mixing process was between 30 to 60 minutes. In this case, for accurate comparison, when comparing the number of microgels according to the type of cellulose derivative composition, a binder solution of the same concentration was prepared and applied at the same thickness, at the same mixing time, and in the same area. The doctor blade gap was controlled between 100 and 200 m.

### Example 1

A (Na+Li)-CMC binder was synthesized from sodium CMC (Na-CMC). The Na-CMC binder was added in 150 ml of ethanol/water (de-ionized water) (90:10, volume ratio) mixed solution containing 7 g of lithium hydroxide monohydrate (LiOH H₂O) to make the mixture react for 1 hour, thereby inducing a sodium/lithium cation (Na+/Li+) substitution reaction. Thereafter, the (Na+Li)-CMC binder was synthesized through vacuum filtering and vacuum drying for 24 hours. A binder solution (1 wt % in water) was prepared using the (Na+Li)-CMC binder prepared for measuring the number of microgels. In this case, the binder was stirred at 1500 rpm using a mixer for 30 minutes to be dissolved in a solvent, and the binder solution was applied onto a transparent sheet through a doctor blade method with a gap of 100 m, and the number of microgels was visually measured in an area of 5×5 cm².

### Example 2

Na-CMC was added in a mixed solution of hydrochloric acid/ethanol (15:85, volume ratio) to make the mixture react for 3 hours, thereby synthesizing carboxylic acid (H-CMC), which was collected through vacuum filtering. Then, the resulting product was added in 150 ml of ethanol/water (de-ionized water) (90:10, volume ratio) mixed solution containing 7 g of lithium hydroxide monohydrate (LiOH H₂O) to make the mixture react for 1 hour so as to induce H+/Li+ substitution reaction, thereby synthesizing Li— CMC. Thereafter, li-CMC was added in 150 ml of ethanol/water (de-ionized water) (90:10, volume ratio) mixed solution containing 7 g of potassium hydroxide (KOH) to make the mixture react for 1 hour, thereby inducing potassium/lithium cation (K+/Li+) substitution reaction. Then, a (K+Li)-CMC binder was synthesized through vacuum filtering and vacuum drying for 24 hours. Measuring the number of microgels was the same as in Example 1, except that the (K+Li)-CMC binder was used.

### Example 3

A (Rb+Li)-CMC binder was synthesized in the same manner as in Example 2, except that an aqueous solution of rubidium hydroxide monohydrate (RbOH.H₂O) was used as a substitution solution instead of an aqueous solution of potassium hydroxide (KOH) in Example 2. Measuring the number of microgels was the same as in Example 1, except that the (Rb+Li)-CMC binder was used.

### Comparative Example 1

To compare multiple metal ion substitution effect of Examples 1 to 3, Na-CMC was selected as Comparative Example and the number of microgels was measured as in Example 1.

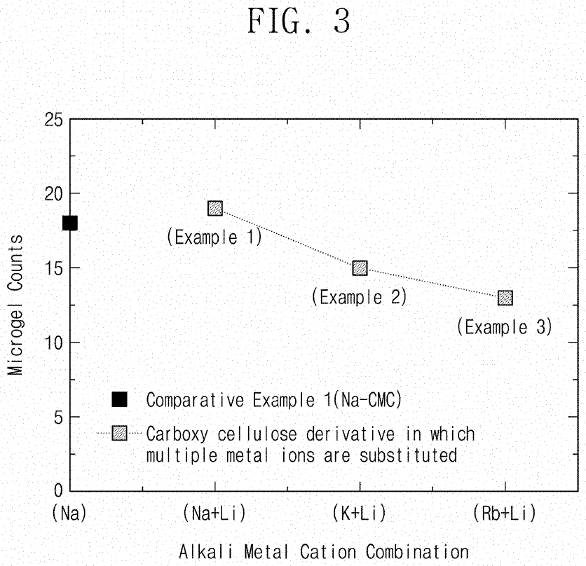

FIG. 3 shows results of measuring the number of microgels in the binder solution (1 wt % in de-ionized water) in Examples 1 to 3 and Comparative Example 1. It was observed that the number of microgels decreased in the order of (Na+Li), (K+Li), and (Rb+Li), and in the case of (Na+Li), the number of microgels similar to or higher than that of pure Na was observed.

According to an embodiment of the inventive concept, metal ions may be multi-substituted in the cellulose derivative composition to reduce formation of microgels, and a substituent in which lithium ions are substituted may be included to improve conductive properties of lithium ions.

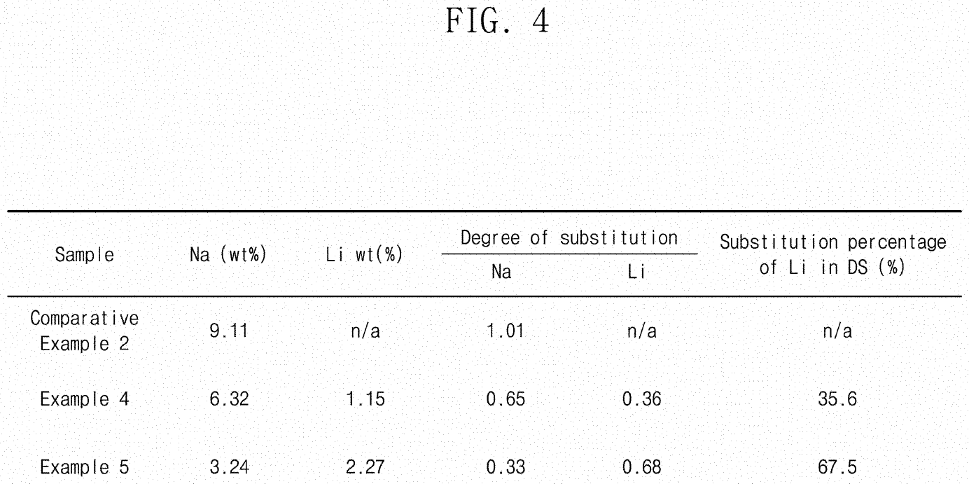

FIG. 4 is a chart showing lithium substitution rates in a cellulose derivative binder in Examples 4 to 5 and Comparative Example 2 (Examples 4 to 5 and Comparative Example 2 below).

### Example 4

A Na-CMC binder was added in 150 ml ethanol/water (de-ionized water) (90:10, volume ratio) mixed solution containing 0.02 M of lithium hydroxide monohydrate ((LiOH.H₂O) to make the mixture react for 0.5 hours, thereby inducing Na+/Li+ cation substitution reaction. Thereafter, a (Na+Li)-CMC binder was synthesized through vacuum filtering and vacuum drying for 24 hours. Analysis of chemical composition may be performed through inductively coupled plasma optical emission spectroscopy (ICP-OES) analysis.

### Example 5

In Example 4, the same process as in Example 4 was applied, except that 150 ml of ethanol/water (de-ionized water) (90:10, volume ratio) mixed solution containing 0.02 M of lithium hydroxide monohydrate (LiOH—H₂O) and reaction for 3 hours were applied instead of 150 ml of ethanol/water (de-ionized water) (90:10, volume ratio) mixed solution containing 0.02 M of lithium hydroxide monohydrate (LiOH—H₂O) and reaction for 0.5 hours. Analysis of chemical composition may be performed through ICP-OES analysis.

### Comparative Example 2

Comparative Example 2 is an analysis of chemical composition of the same Na-CMC binder used in Comparative Example 1 through ICP-OES analysis.

Referring to FIG. 4, the lithium substitution rate varies depending on lithiation reaction conditions, and Examples 4 and 5 show lithium substitution rates of 35.6% and 67.5%, respectively.

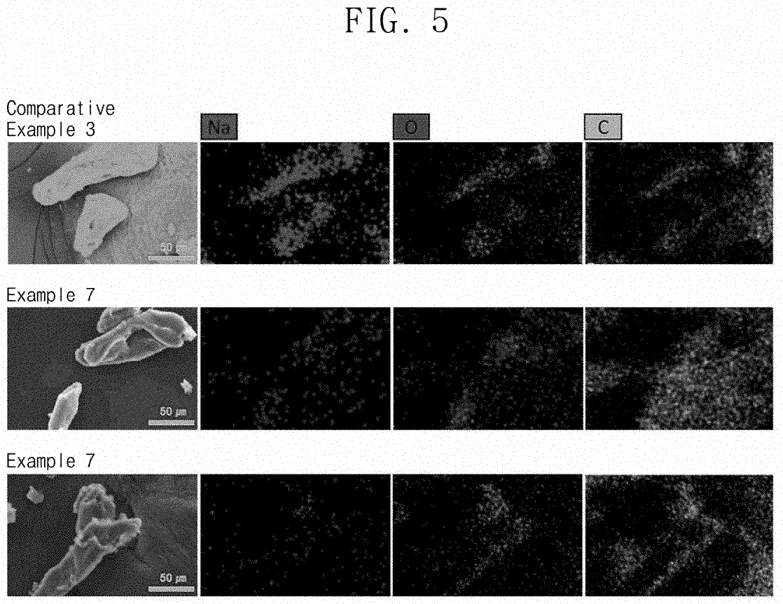

FIG. 5 is a microscope image of cellulose derivatives in Examples 6 and 7 and Comparative Example 3.

### Example 6

The shape of the (Na+Li)-CMC binder synthesized in Example 4 was imaged through SEM analysis, and the shape of each element was imaged through EDS-mapping.

### Example 7

The shape of the (Na+Li)-CMC binder synthesized in Example 5 was imaged through SEM analysis, and the shape of each element was imaged through EDS-mapping.

### Comparative Example 3

In Comparative Example 3, the shape of the same Na-CMC binder used in Comparative Example 1 was imaged through SEM analysis, and the shape of each element was imaged through EDS-mapping.

FIG. 5 is a shape image of a cellulose derivative through scanning electron microscopy (SEM) analysis. Referring to FIG. 5, it is seen that sodium signals are weakened as the lithium substitution rate increases through EDS mapping analysis corresponding to the SEM image. In the case of lithium, as a light element, information is not available through EDS mapping analysis.

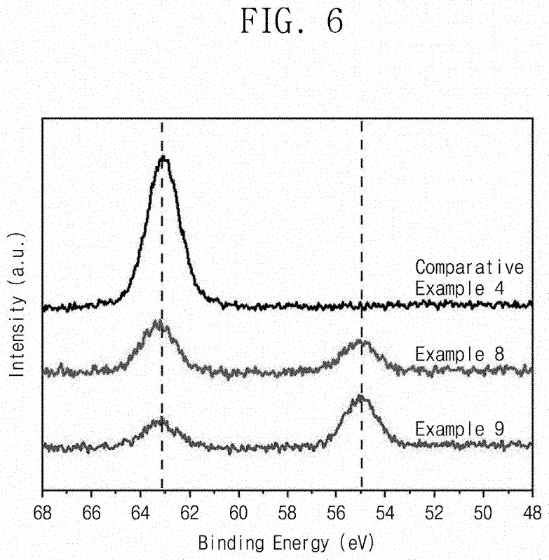

FIG. 6 is a graph of chemical composition analysis in Examples 8 and 9 and Comparative Example 4.

### Example 8

The (Na+Li)-CMC binder synthesized in Example 4 was analyzed for composition of Na and Li elements through XPS analysis.

### Example 9

The (Na+Li)-CMC binder synthesized in Example 5 was analyzed for composition of Na and Li elements through XPS analysis.

### Comparative Example 4

In Comparative Example 4, the same Na-CMC binder as used in Comparative Example 1 was analyzed for composition of Na and Li elements through XPS analysis.

The chemical composition analysis in FIG. 6 was analyzed through X-ray photoelectron microscopy (XPS), and referring to FIG. 6, although only sodium signals were observed in Comparative Example 4, it is seen that sodium and lithium signals were observed together in Examples 8 and 9.

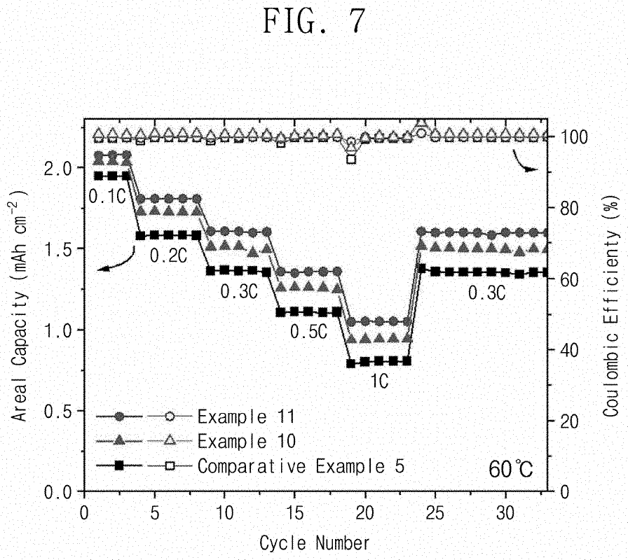

FIG. 7 is a graph showing charge/discharge capacity of negative electrodes in Examples 10 and 11 and Comparative Example 5.

### Example 10

Using natural graphite as an electrode active material, a mixed binder of (Na+Li)-CMC and styrene-butadiene rubber (SBR) synthesized in Example 4 as a binder, and de-ionized water as a solvent, an electrode for an all-solid-state secondary battery in which an electrolyte component such as liquid or solid was excluded in an electrode was manufactured through a slurry process. The composition of the electrode is natural graphite:(Na+Li)-CMC:SBR=97:2:1 by weight ratio. To precisely mix the slurry, mixing was performed in the range of 1000 to 2000 rpm using a planetary mixer. To prepare an electrode slurry, natural graphite and (Na+Li)-CMC binder solution (1.5 wt % in deionized water) were first mixed at 1500 rpm for 10 minutes. Then, an additional SBR emulsion solution (40 wt %) was added and mixed again for 10 minutes. The electrode was applied onto a nickel foil through a doctor blade method. After the applying, initial drying was performed at 100° C., vacuum drying was performed at 90° C. for 10 to 15 hours, and the density of the electrode was raised through a compression process. A lithium foil having a thickness of 300 m was used as a counter electrode to construct a graphite/lithium half-cell. Li₆PS₅Cl (LPSCl) was used as a solid electrolyte layer between both electrodes. To prepare an all-solid-state secondary battery, the LPSCl solid electrolyte layer was first pre-pressurized at a pressure of 50 Mpa to a thickness of 1000 m. Then, a (Na+Li)-CMC binder-based graphite electrode was contacted on one side of LPSCl, and a close interface was formed at a pressure of 350 MPa. Thereafter, the lithium foil was contacted on the opposite side of LPSCl, and then a pressure of 50 Mpa was applied thereto to complete an all-solid-state secondary battery.

Based on a CC-CV mode, the cut-off current was set to 1/10 according to applied current in a voltage section of 0.01 to 2 V, and at the same time, the cut-off time was set to add 10% from the time calculated according to the applied current. For example, in the case of 0.1 C, since the calculated charge/discharge time is 10 hours, 11 hours is set as the cut-off time in the present embodiment. To analyze capacity characteristics according to the applied current density, charge/discharge driving was applied in 3 cycles of 0.1 C, 5 cycles of 0.2, 0.3, 0.5, and 1 C each, and 10 cycles of 0.3 C. In addition, to improve the rate of ion diffusion within a relatively slow electrode, all charge/discharge tests were performed at 60° C.

### Example 11

The same process as in Example 4 was applied, except that the (Na+Li)-CMC binder synthesized in Example 5 was used.

### Comparative Example 5

In Comparative Example 5, the same process as in Example 4 was applied, except that Na-CMC, a non-ion conductive binder, was used.

In FIG. 7, the charge/discharge capacity of a graphite negative electrode formed of only graphite and a binder is compared as a solid or liquid electrolyte component prepared based on the cellulose derivative binder is completely excluded. Referring to FIG. 7, high capacity characteristics were shown to be high in a sequence of Comparative Example 5<Example 10<Example 11 with respect to changes in current density (0.1, 0.2, 0.3, 0.5, 1, 0.3 C), and when the lithium substitution rate increased, higher performance was shown.

That is, electrical properties of the all-solid-state secondary battery may be improved by the cellulose derivative composition according to an embodiment of the inventive concept. This is because, as described with reference to FIG. 3, the formation of microgels is reduced and lithium ion transfer properties are improved by including a substituent in which lithium ions are substituted.

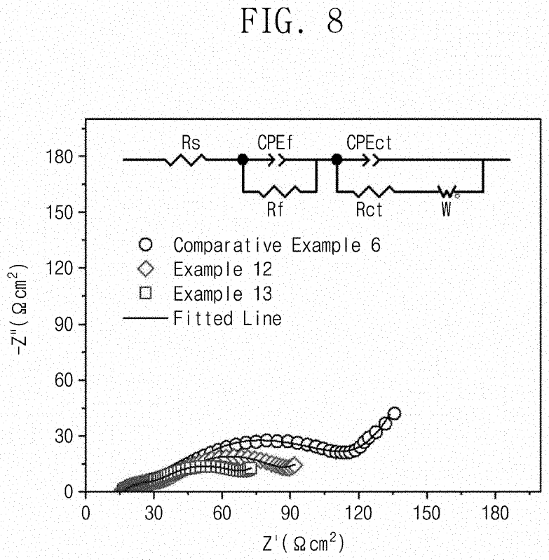

FIG. 8 is a graph showing internal resistance of negative electrodes in Examples 12 and 13 and Comparative Example 6.

### Example 12

After analyzing the charge/discharge capacity characteristics according to the applied current density of the electrode-based all-solid-state secondary battery to which the (Na+Li)-CMC binder synthesized in Example 10 was applied, impedance analysis was performed.

### Example 13

After analyzing the charge/discharge capacity characteristics according to the applied current density of the electrode-based all-solid-state secondary battery to which the (Na+Li)-CMC binder synthesized in Example 11 was applied, impedance analysis was performed.

### Comparative Example 6

In Comparative Example 6, after analyzing the charge/discharge capacity characteristics according to the applied current density of the electrode-based all-solid-state secondary battery to which the Na-CMC binder synthesized in Comparative Example 5 was applied, impedance analysis was performed.

In FIG. 8, internal resistance of a graphite negative electrode prepared based on a cellulose derivative binder is measured. Referring to FIG. 8, the internal resistance in the electrode is inversely proportional to the lithium substitution rate, and is high in a sequence of Example 13<Example 12<Comparative Example 6.

That is, electrical properties of the all-solid-state secondary battery may be improved by the cellulose derivative composition according to an embodiment of the inventive concept. This is because, as described with reference to FIG. 3, the formation of microgels is reduced and lithium ion transfer properties are improved by including a substituent in which lithium ions are substituted.

According to the inventive concept, monovalent metal ions are substituted in a cellulose derivative composition to suppress hydrophobicity due to attraction between cellulose polymers, thereby maintaining high solubility in aqueous solution. Accordingly, formation of microgels may be reduced to improve electrical properties of an all-solid-state secondary battery.

In addition, the cellulose derivative composition according to the inventive concept may include a substituent in which lithium ions are substituted. Accordingly, conductive properties of lithium ions are improved, and thus, even when an electrolyte component is excluded upon electrode manufacturing and driving, a lithium ion transfer path is provided through a binder, thereby lowering interfacial resistance inside a secondary battery and enabling fast transfer of lithium ions. Accordingly, electrical properties of an all-solid-state secondary battery may be improved.

Although the embodiments of the inventive concept have been described above with reference to the accompanying drawings, those skilled in the art to which the inventive concept pertains may implement the inventive concept in other specific forms without changing the technical idea or essential features thereof. Therefore, the above-described embodiments are to be considered in all aspects as illustrative and not restrictive.

Effects of the present disclosure are not limited to the effects described above, and those skilled in the art may understand other effects from the following description.

What is claimed is:

1. An electrode comprising a binder formed of a cellulose derivative composition containing a compound represented by Formula 1 below: 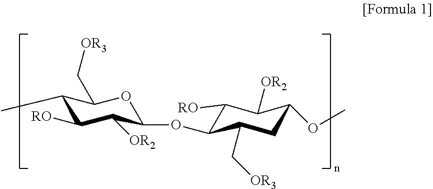
wherein in Formula 1, R₁, R₁′, R₂, R₂′, R₃, and R₃′ are each independently a carboxymethyl group, a sulfur substituent, or a phosphorus substituent, in which a monovalent metal is substituted, or hydrogen.

2. An all-solid-state secondary battery comprising an electrode including a binder formed of the cellulose derivative composition of claim 1.

3. The electrode of claim 1, wherein R₁, R₂, and R₃ are each independently —CH₂COOX where X is sodium (Na), potassium (K), rubidium (Rb), or cesium (Cs), and
R₁′, R₂′, and R₃′ are each independently —CH₂COOY where Y is lithium (Li).

4. The electrode of claim 1, wherein R₁, R₂, and R₃ are each independently —SO₃X where X is sodium (Na), potassium (K), rubidium (Rb), or cesium (Cs), and
R₁′, R₂′, and R₃′ are each independently —SO₃Y where Y is lithium (Li).

5. The electrode of claim 1, wherein R₁, R₂, and R₃ are each independently —PO₃X or —PO₃X₂ where X is sodium (Na), potassium (K), rubidium (Rb), or cesium (Cs), and
R₁′, R₂′, and R₃′ are each independently —PO₃Y or —PO₃Y₂ where Y is lithium (Li).

6. The electrode of claim 1, wherein the cellulose derivative composition comprises cellulose, methyl cellulose, ethyl cellulose, butyl cellulose, hydroxypropyl cellulose, cellulose nitrate, cellulose acetate, cellulose acetate propionate, cellulose acetate butyrate, carboxymethyl cellulose, xanthan gum, pectin, guar gum, or dextran derivatives.

7. The electrode of claim 1, wherein the electrode comprises an electrode active material,
the electrode active material including graphite, hard carbon, soft carbon, carbon nanotubes, graphene, redox graphene, carbon fiber, amorphous carbon, or silicon-carbon composite (SiC).

8. The electrode of claim 7, wherein the electrode active material has a conductivity of about 2 S/cm or greater.

9. The electrode of claim 7, wherein a weight ratio of the electrode active material and the binder solution is about 90:10 to about 99:1.

10. The electrode of claim 1, wherein the binder formed of the cellulose derivative composition comprises a cellulose derivative composition and a styrene-butadiene rubber (SBR) emulsion.

11. The electrode of claim 10, wherein a weight ratio between the cellulose derivative composition and the SBR emulsion is about 60:40 to about 90:10.

12. The electrode of claim 1, wherein when the cellulose derivative composition comprising the compound represented by Formula 1 above is dissolved in 1 wt % (in de-ionized water), the number of microgel phases is reduced compared to when the compound represented by Formula 1 is not included.

13. The all-solid-state secondary battery of claim 2, wherein the electrode comprises an electrode active material, and
ion transfer within the electrode is achieved through contact between the electrode active materials and through the ion-conductive binder.

14. The all-solid-state secondary battery of claim 2, wherein the electrode does not contain a liquid or solid electrolyte and a conductive material.

15. The all-solid-state secondary battery of claim 2, wherein pores in the electrode without an electrolyte component are within 15%.
